(19) United States
(12) Patent Application Publication
(10) Pub. No.: US 2006/0290030 A1
(43) Pub. Date: Dec. 28, 2006

(54) Manufacture method for molded product

(75) Inventors: Shuichi Tamaki, Nishio-city (JP); Hisashi Sawada, Okazaki-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/476,280

(22) Filed: Jun. 28, 2006

(30) Foreign Application Priority Data
Jun. 28, 2005 (JP) 2005-188519
Mar. 28, 2006 (JP) 2006-087871

(51) Int. Cl. B29C 45/00

(52) U.S. Cl. 264/328.7; 264/328.16

(57) ABSTRACT

A manufacture method is provided for a molded product having a thin-walled member and a thick-walled member which are crosswise arranged. A slide plate of a mold is slid so that an interval between thin-walled-member inner wall surfaces of mold members of the mold is enlarged. The thin-walled-member inner wall surfaces are opposite to each other with the thin-walled member being inserted therebetween. Thus, a constraint of the thin-walled member by the mold is released, so that the thin-walled member can move corresponding to the crystallization shrinkage of the thick-walled member which is cooled later than the thin-walled member. Thus, crack can be restricted at the crosswise connection part between the thin-walled member and the thick-walled member.

### CROSS REFERENCE TO RELATED APPLICATION

This application is based on Japanese Patent Applications No. 2005-188519 filed on Jun. 28, 2005 and No. 2006-87871 filed on Mar. 28, 2006, the disclosure of which is incorporated herein by reference.

### FIELD OF THE INVENTION

The present invention relates to a manufacture method for a molded product having members which respectively have thicknesses different from each other.

### BACKGROUND OF THE INVENTION

Referring to JP-2004-34548A, a resin molding device is provided to mold a sirocco fan via a mold. Generally, a centrifugal fan (e.g., sirocco fan) has multiple fan blades, a disk member for connecting the fan blades with a rotation shaft, a shroud ring which is arranged at an opposite side to the connection part of the disk member to integrally connect the fan blades with each other, and the like.

Recently, the diameter of the centrifugal fan is small-sized in support of needs. It is desirable that the fan blade is thin-walled. In the case where the fan blade is thin-walled, the air-flow resistance thereof will decrease so that the air quantity supplied by the centrifugal fan can increase, and the moment thereof will decrease because of the weight reduction so that the high-speed rotation becomes possible.

However, when the molding of the sirocco fan having the thin-walled fan blades was tried by inventors of the present invention, crack occurred at the connection part between the fan blade and the disk member and that between the fan blade and the shroud ring. That is, crack was caused at the crosswise connection part between the thick-walled member (disk member and shroud ring) and the thin-walled member (fan blade).

According to the research of the inventors of the present invention, the fault (crack) is caused due to a cooling time difference in the molding course between the thin-walled member (fan blade) and the thick-walled member (disk member and shroud ring).

Specifically, there exits a difference between the shrinkage states of the thin-walled member and the thick-walled member, which is cooled and solidified later than the thin-walled member. Therefore, stress occurs at the crosswise connection part between the thin-walled member and the thick-walled member, thus causing the crack.

### SUMMARY OF THE INVENTION

In view of the above-described disadvantages, it is an object of the present invention to provide a manufacture method for a molded product, to restrict crack at a crosswise connection part between a thin-walled member and a thick-walled member of the molded product.

According to the present invention, a manufacture method is provided for a molded product having at least a thick-walled member and at least a thin-walled member which are crosswise arranged. The thin-walled member has a smaller thickness than the thick-walled member. The manufacture method includes a charging process for ejecting and charging a molten resin into a product portion of a mold having been mold-closed, a cooling process for cooling and solidifying the molten resin (having been charged into product portion in charging process) in a constraint state in the product portion, and a mold-releasing process for mold-opening the mold and taking out the molded product (having been solidified in cooling process) from the production portion. In the cooling process, the constraint of the thin-walled member by the mold is released when a first predetermined time has elapsed from the charging of the molten resin in the charging process. In the mold-releasing process, the mold is mold-opened to separate at least the thick-walled member from a part of the mold when a second predetermined time has elapsed from the charging of the molten resin in the charging process, after the release of the constraint in the cooling process.

Thus, in the cooling process, the constraint (by product portion of mold) of the thin-walled member which has been earlier cooled and solidified is released when the first predetermine time has elapsed from the charging of the molten resin. Therefore, the thin-walled member can move corresponding to the shrinkage of the thick-walled member, even when there is a difference between the shrinkage states of the thin-walled member and the thick-walled member. Accordingly, crack can be restricted from occurring at the crosswise connection part between the thin-walled member and the thick-walled member.

### BRIEF DESCRIPTION OF THE DRAWINGS

Other objects, features and advantages of the present invention will become more apparent from the following detailed description made with reference to the accompanying drawings, in which:

FIG. 1 is a schematic sectional view showing a mold for manufacturing a sirocco fan according to a first embodiment of the present invention;

FIG. 2 is a schematic block diagram showing a construction of a molding device according to the first embodiment;

FIG. 3 is a schematic perspective view showing a construction of the sirocco fan according to the first embodiment;

FIG. 4 is a schematic view showing a position relation between the sirocco fan and gates according to the first embodiment;

FIG. 5 is a schematic perspective view showing a relation between the sirocco fan and a main part of the mold according to the first embodiment;

FIG. 6 is a schematic sectional view of the mold which shows a mold-closing process in a molding cycle according to the first embodiment;

FIG. 7 is a schematic sectional view of the mold which shows a charging process in the molding cycle according to the first embodiment;

FIG. 8 is a schematic sectional view of the mold which shows a mold-opening process in the molding cycle according to the first embodiment;

FIG. 9 is a schematic sectional view of the mold which shows a mold-releasing process in the molding cycle according to the first embodiment;

FIG. 10 is a vertical sectional view taken along the line X-X in FIG. 7;

FIG. 11A is a schematic sectional view of the mold which shows a slide of a slide plate between mold plates according to the first embodiment, and FIG. 11B is a vertical sectional view taken along the line XIB-XIB in FIG. 11A;

FIG. 12 is a schematic sectional view of the mold which shows a further slide of the slide plate between the mold members according to the first embodiment;

FIG. 13 is a time chart showing operations of the molding device when the molding cycle is performed according to the first embodiment;

FIG. 14 is a graph showing resin temperature variation in a cooling process according to the first embodiment;

FIGS. 15A, 15B and 15C are schematic sectional views of a mold respectively showing different molding processes according to other embodiments of the present invention;

FIGS. 16A, 16B and 16C are schematic sectional views of a mold respectively showing different molding processes according to the other embodiments; and

FIGS. 17A, 17B, 17C and 17D are schematic sectional views of a mold respectively showing different molding processes according to the other embodiments.

### DETAILED DESCRIPTION OF THE EXAMPLE EMBODIMENTS

### First Embodiment

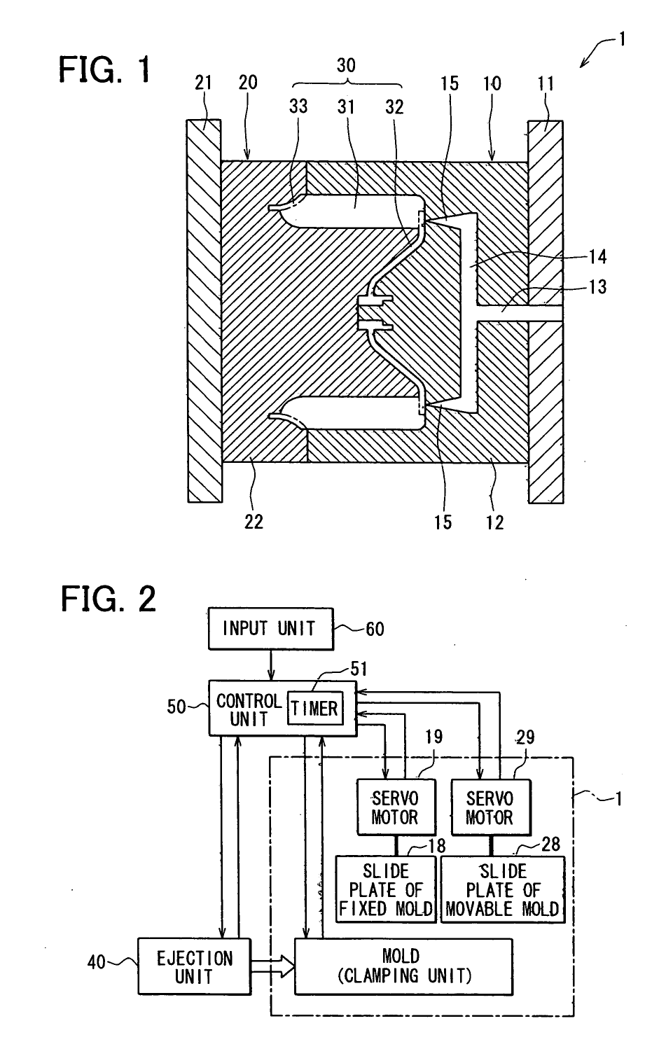

A manufacture method for a molded product according to a first embodiment of the present invention will be described with reference to FIGS. 1-14. The manufacture method can be suitably used for a centrifugal fan 100 such as a sirocco fan, for example.

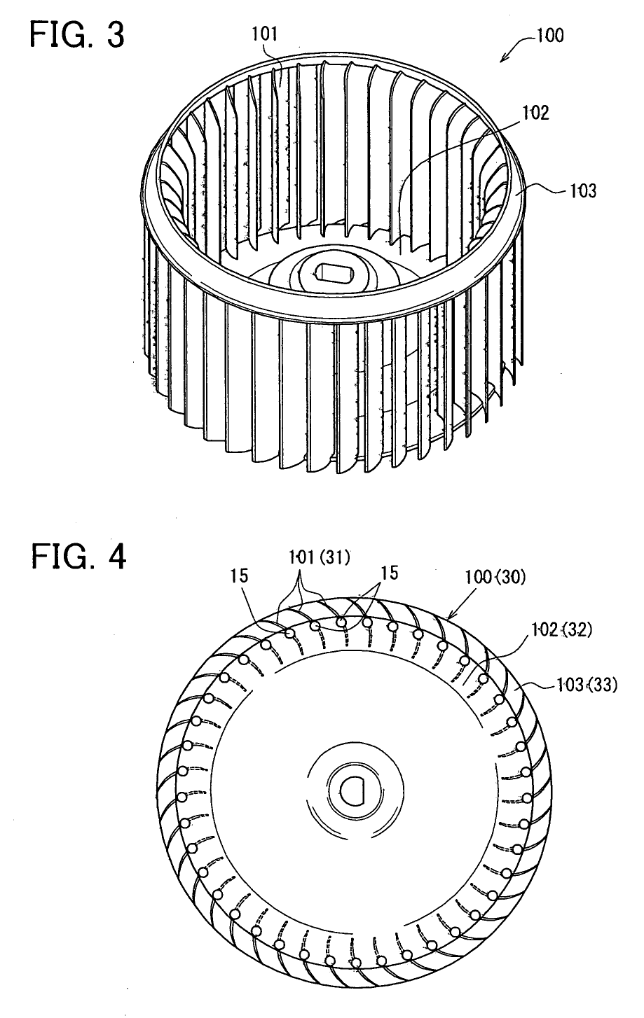

Referring to FIG. 3, the sirocco fan 100, being made of a resin (such as polypropylene and polyamide) or the like, has multiple fan blades 101 which are circumferentially arrayed, a disk member 102 and a shroud ring 103. Each of the fan blades 101 extends, for example, in an up-down direction of FIG. 3. The disk member 102 and the shroud ring 103 are respectively connected with two extending-direction ends (e.g., lower end and upper end shown in FIG. 3) of each of the fan blades 101. The disk member 102 is provided with a rotation-shaft connection hole at a substantial center thereof.

The fan blade 101 has a thickness of about 0.2 mm, for example. The disk member 102 has a thickness of about 1.8 mm, for example. The shroud ring 103 can have a same thickness with the disk member 102. In this case, there is a crosswise connection between the thick-walled member (disk member 102 and shroud ring 103) and the thin-walled member (fan blade 101), with respect to the thickness direction thereof, for example.

As shown in FIG. 1, the manufacture method is suitably used for the molded product such as the sirocco fan 100 via a mold 1. The mold 1 includes a fixed mold unit 10 which has a fixed disk 11 attached to a fixed platen of an ejection molding device (not shown), and a movable mold unit 20 which has a movable disk 21 attached to a movable platen (not shown). The movable platen is capable of moving to-and-fro with respect to the fixed platen.

The fixed mold unit 10 has a mold plate 12, which has a concave-convex shape (projection-depression shape) at the side of the movable mold unit 20. Similarly, the movable mold unit 20 has a mold plate 22, which has a concave-convex shape (projection-depression shape) at the side of the fixed mold unit 10. When the fixed mold unit 10 and the movable mold unit 20 are mold-mated (mold-closed), there exists a space between the fixed mold unit 10 and the movable mold unit 20. The space constructs a product portion 30 for molding the sirocco fan 100.

The fixed mold unit 10 has therein a sprue 13 and a runner 14, each of which is a passage for supplying the molten resin for the product portion 30. The fixed mold unit 10 is further provided with multiple gates 15, each of which is positioned at a downstream end of the runner 14 to be an injection opening of the molten resin for the product portion 30.

The gate 15 is arranged in an extension direction (at right side of FIG. 1) of a fan-blade molding portion 31 (thin-walled-member molding portion) of the product portion 30. The gate 15 is constructed such that the molten resin is injected toward the fan-blade molding portion 31.

As shown in FIG. 4, the multiple gates 15 of the mold 1 are respectively provided for the multiple fan blades 101 of the sirocco fan 100. That is, the multiple gates 15 are arranged to respectively correspond to the multiple fan-blade molding portions 31 of the product portion 30.

FIG. 4 shows a relative position of the sirocco fan 100 to the gates 15 when being viewed from the side of the fixed mold unit 10, and a relative position of the product portion 30 of the mold 1 to the gates 15.

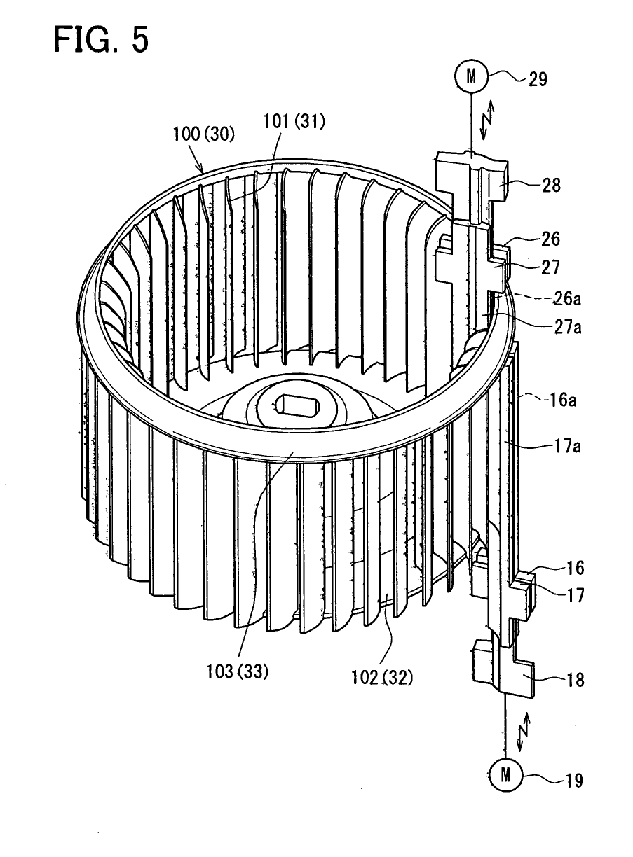

As shown in FIG. 5, the fixed mold unit 10 has multiple (e.g., three) mold members 16, 17 and 18, which are arranged between the adjacent fan blades 101 (fan-blade molding portion 31 of product portion 30) of the sirocco fan 100 and positioned at a lower side (referring to FIG. 5) of the shroud ring 103 (shroud-ring molding portion 33 of product portion 30). The mold members 16, 17 and 18 are not shown in FIG. 1.

Specifically, the mold member 16 can be constructed of a mold plate, and has an inner wall surface 16a (thin-walled-member inner wall surface) which faces the product portion 30. The mold member 17 can be constructed of a mold plate, and has an inner wall surface 17a (thin-walled-member inner wall surface) which faces the product portion 30. The mold member 18 can be constructed of a slide plate, which has a substantial wedge shape and is arranged between the mold member 16 and the mold member 17. The mold members 16-18 can be tiered, for example.

The slide plate 18 is connected with an output end of a servo motor 19 which is a driving unit for slide. The slide plate 18 is driven by the servo motor 19 to be slid (that is, move to-and-fro) between the mold plate 16 and the mold plate 17, and the inner wall surface 16a of the mold plate 16 and the inner wall surface 17a of the mold plate 17 can be moved in a direction perpendicular to the slide direction of the slide plate 18.

The movable mold unit 20 has multiple (e.g., three) mold members 26, 27 and 28, which are arranged between the adjacent fan blades 101 (fan-blade molding portion 31 of product portion 30) of the sirocco fan 100 and positioned at an upper side (referring to FIG. 5) of the disk member 102 (disk-member molding portion 32 of product portion 30).

Specifically, the mold member 26 can be constructed of a mold plate, and has an inner wall surface 26a (thin-walled-member inner wall surface) which faces the product portion 30. The mold member 27 can be constructed of a mold plate, and has an inner wall surface 27a (thin-walled-member inner wall surface) which faces the product portion 30. The mold member 28 can be constructed of a slide plate which has a substantial wedge shape and is arranged between the mold plates 26 and 27. The mold members 26-28 can be tiered, for example.

The slide plate 28 is connected with an output end of a servo motor 29 which is a driving unit for slide. The slide plate 28 is driven by the servo motor 29 to be slid (that is, move to-and-fro) between the mold plate 26 and the mold plate 27, and the inner wall surface 26a of the mold plate 26 and the inner wall surface 27a of the mold plate 27 can be moved in a direction perpendicular to the slide direction of the slide plate 28.

As shown in FIG. 2, a molding device according to this embodiment mainly includes the mold 1 where the mold members 16-18, 26-28 and the servo motors 19, 29 are embedded, and a well-known ejection unit 40 (ejecting charging unit) for ejecting the molten resin into the mold 1. The mold 1 and the ejection unit 40 are mounted at a well-known molding-device clamping unit.

A control unit 50 controls operations of the ejection unit 40 and the clamping unit where the mold 1 is mounted.

The control unit 50 outputs signals into the ejection unit 40 and the clamping unit where the mold 1 is mounted, and operation-completion signals or data signals from the ejection unit 40 and the clamping unit are inputted into the control unit 50. Thus, a well-known molding cycle can be performed. The molding cycle sequentially includes a mold closing (clamping) of the mold 1, an ejecting-charging of the molten resin into the product portion 30 of the mold 1 (having been mold-closed) via the ejection unit 40, a cooling-solidifying of the molten resin having been charged into the product portion 30, a mold opening of the mold 1 after the cooling-solidifying of the molten resin in the product portion 30, and a taking-out of the sirocco fan 100 (having been solidified) from the product portion 30 of the mold 1 which is mold-opened.

Moreover, the control unit 50 outputs operation signals to the servo motors 19 and 29 which are embedded in the mold 1, and operation state signals from the servo motors 19 and 29 are inputted into the control unit 50.

The control unit 50, having therein a memorizing unit, memorizes a molding condition of the sirocco fan 100 and the like inputted via an input device 60 (input unit). Moreover, the control unit 50 grasps the progression situation of the molding cycle, based on the signals from the mold 1 (practically, clamping unit) and the ejection unit 40.

The control unit 50, being provided with a timer 51 as a timer unit, outputs the operation signals to the clamping unit (mold 1 including servo motors 19 and 29), the ejection unit 40 and the like when a predetermined time beforehand set for the timer 51 has elapsed.

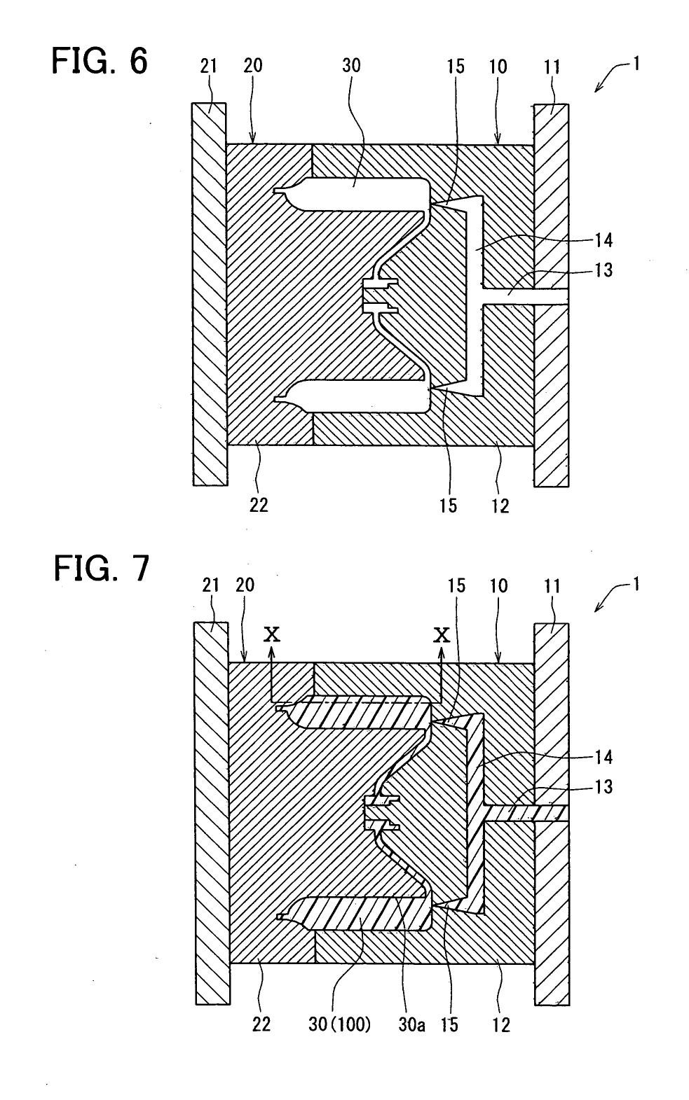

Next, it will be described the manufacture method for the molded product such as the sirocco fan 100 via the above-described molding device. The molding cycle for molding the sirocco fan 100 will be described with reference to FIGS. 6-9.

FIG. 6 shows a mold-closing (clamping) process for mold-closing the mold 1. FIG. 7 shows a charging process for ejecting and charging the molten resin into the product portion 30 of the mold 1, and a cooling process for cooling and solidifying the molten resin (which is charged in the charge process) in the product portion 30.

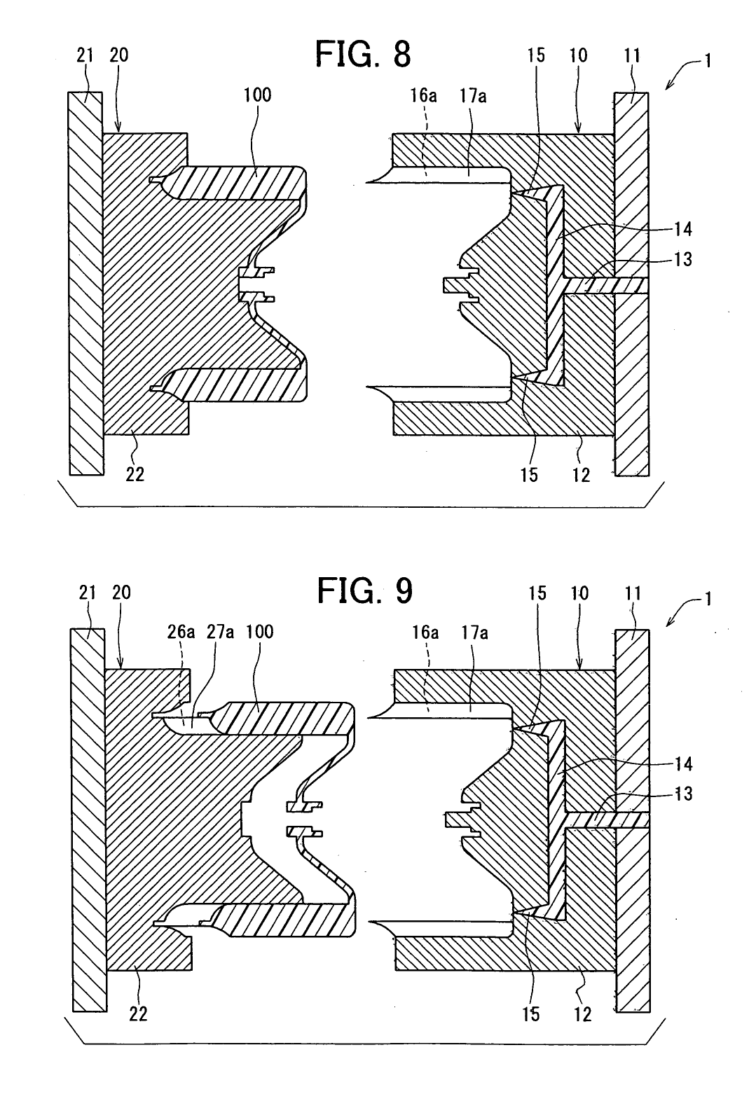

FIG. 8 shows a mold-opening process for mold-opening the mold 1. FIG. 9 shows a taking-out process for taking out the sirocco fan 100 (having been solidified) from the product portion 30 of the mold 1 (having been mold-opened). The mold-opening process and the taking-out process correspond to a mold-releasing process in this embodiment.

At first, the fixed mold unit 10 and the movable mold unit 20 are mated to mold-close the mold 1 as shown in FIG. 6, when the control unit 50 controls (referring to FIG. 2) the ejection unit 40 and the mold 1 (practically, clamping unit) to mold the sirocco fan 100.

Next, as shown in FIG. 7, a nozzle portion (not shown) of the ejection unit 40 (referring to FIG. 2) is contacted with an upstream end of the sprue 13 of the mold 1 having been mold-closed, and the liquid molten resin is ejected thereto. Thus, the molten resin flows into the sprue 13 and the runner 14, to be charged into the product portion 30 through the gates 15.

The molten resin is injected toward the fan-blade molding portion 31 from the multiple gates 15, which are arranged to respectively correspond to the multiple fan-blade molding portions 31 of the product portion 30.

Thus, the molten resin can be readily injected to the fan-blade molding portions 31 (for molding thin-walled fan blades 101) of the product portion 30 of the mold 1. That is, the ejection pressure can be restricted even when the molded product having the multiple thin-walled members is molded.

In this embodiment, when the molten resin is charged into the product portion 30, the temperature of an inner wall surface 30a of the product portion 30 of the mold 1 is set to be a relatively low temperature (e.g., 20° C.) within a temperature field (crystallization temperature range) where crystallization of the resin develops, considering a molding productivity.

On contrast, when the molten resin is charged, the temperature of the inner wall surface 30a of the mold 1 is set in the proximity of an upper-limit temperature of the crystallization temperature range of the resin which is ejected and charged. That is, the temperature of the inner wall surface 30a of the mold 1 can be a relatively high temperature (practically, upper-limit temperature), for example, 120° C., within the crystallization temperature range where the crystallization of the resin develops.

In this case, the temperature of the inner wall surface 30a of the mold 1 is set, based on a flow property of the ejected-charged resin and a shrinkage property accompanying with the crystallization and the like. Accordingly, the molten resin which is injected into the product portion 30 can be charged while maintaining a low viscosity at a relatively high temperature. Moreover, the crystallization of the resin having been charged can develop. Thus, the ejection pressure can be further restricted.

After the molten resin which is charged into the product portion 30 is cooled and solidified and the sirocco fan 100 is molded, the fixed mold unit 10 and the movable mold unit 20 are mold-opened as shown in FIG. 8.

Then, referring to FIG. 9, an ejector device (not shown) or the like is operated to mold-release the sirocco fan 100. The sirocco fan 100 is taken out from the part between the fixed mold unit 10 and the movable mold unit 20 via a dismounting device (not shown).

When the sirocco fan 100 is mold-released, a runner plate (not shown) and the like are operated to remove the resin solidified in the sprue 13 and the runner 14. That is not shown in FIGS. 8 and 9.

Next, the operation of the main construction according to this embodiment will be described.

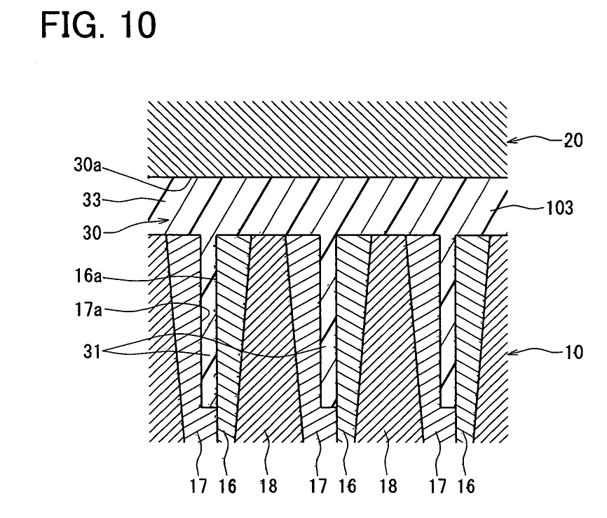

When the charging process shown in FIG. 7 is performed so that the molten resin is injected into the product portion 30 of the mold 1, the molten resin will be charged into the fan-blade molding portion 31 between the mold plate 16 and the mold plate 17 of the side of the fixed mold unit 10 and into the shroud-ring molding portion 33 between the fixed mold unit 10 and the movable mold unit 20 as shown in FIG. 10. Thus, the molten resin charged into the product portion 30 will be cooled and solidified, in such a state that the molten resin is heat-absorbed by the mold 1 and constrained by the inner wall surface 30a.

FIG. 14 shows the temperature variation of the resin in the cooling process. Referring to FIG. 14, the fan blade 101 which is the thin-walled member is rapidly cooled and solidified, as compared with the disk member 12 or the shroud ring 103 (shown in FIG. 10) which is the thick-walled member. When the temperature of the fan blade 101 is in the crystallization temperature range of the resin, the resin crystallization of the fan blade 101 performs. The crystallization temperature range of the resin is a range (where crystallization performs) including the temperature lower than or equal to the crystallization commencement temperature thereof.

On contrast, the shroud ring 103 (disk member 102) is cooled and attains to the crystallization commencement temperature of the resin to be solidified, later than the fan blade 101.

As shown in FIG. 14, the surface portion (which contacts inner wall surface 30a of mold 1) of the thick-walled shroud ring 103 and that of the thin-walled fan blade 101 are substantially comparably cooled, although the cooling of the surface portion of the shroud ring 103 is slightly later because of a thermal capacity difference between the thick-walled member (shroud ring 103) and the thin-walled member (fan blade 101).

On contrast, the thickness-direction middle portion of the fan blade 101 is cooled obviously earlier than and that of the shroud ring 103.

That is, the surface portion of the shroud ring 103 (thick-walled member) and that of the fan blade 101 (thin-walled member) substantially simultaneously attain to the crystallization commencement temperature (e.g., 190° C.). However, the thickness-direction whole region of the shroud ring 103 attains to the crystallization commencement temperature much later than that of the fan blade 101.

Thus, referring to FIG. 14, until the whole region (from surface portion to middle portion) of the thin-walled member attains to the crystallization commencement temperature, the thick-walled member attains to the crystallization commencement temperature sequentially from the side of the surface portion to the side of the middle portion thereof.

In this case, after the thickness-direction whole region of the thin-walled member attains to the crystallization commencement temperature, the part of the thick-walled member, which has not attained to the crystallization commencement temperature at the time when the whole region of the thin-walled member attained, will sequentially attain to the crystallization commencement temperature from the surface side toward the middle side of the thick-walled member.

Therefore, before the crystallization of the whole region of the thin-walled member begins, the surface portion of the thick-walled member performs the crystallization substantially equivalent to the thin-walled member. In this case, the difference between the shrinkage amount (accompanying with crystallization) of the thin-walled member and that of the thick-walled member is relatively small.

After the crystallization of the whole region of the thin-walled member commences, the shrinkage amount (accompanying with crystallization) of the thick-walled member will become larger than that of the thin-walled member because the crystallization commencement region of the thick-walled member sequentially increases.

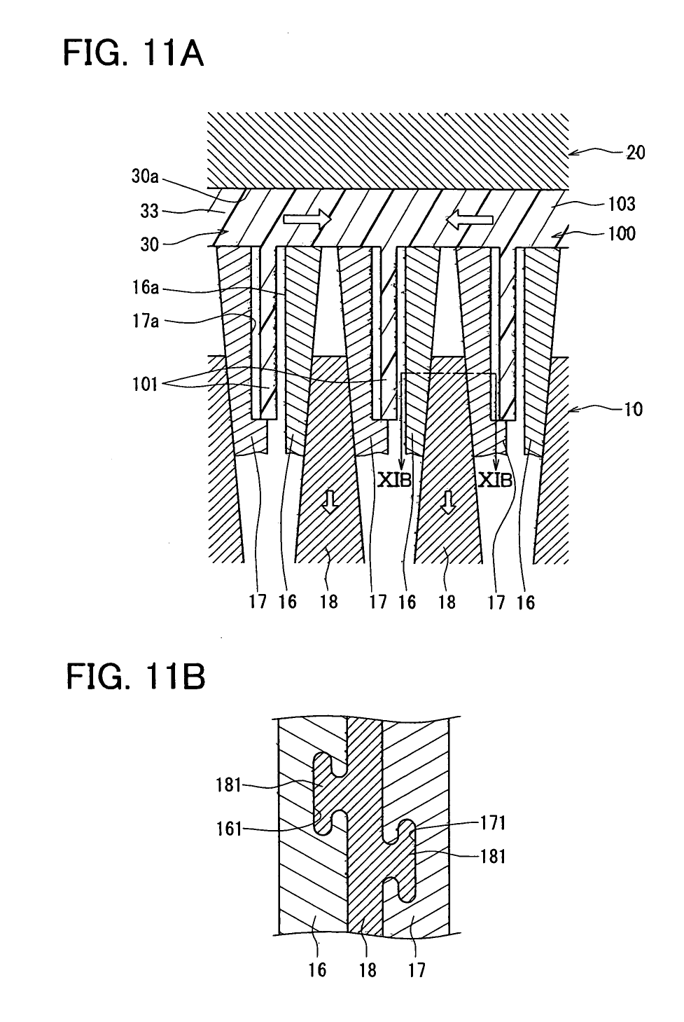

That is, after the crystallization commences in the whole region of the fan blade 101, the shrinkage accompanying with the crystallization occurs in the circumferential direction (indicated by the arrow direction in FIG. 11A) of the shroud ring 103. The shrinkage is larger than that of the fan blade 101.

The above description about the shroud ring 103 with reference to FIG. 14 is also suitably used for the disk member 12, which is the thick-walled member as compared with the fan blade 101.

The control unit 50 operates the servo motor 19 (shown in FIG. 5) to drive (slide) the slide plate 18 in a pulling-out direction from the part between the mold plate 16 and the mold plate 17, referring to FIG. 11A.

The slide plate 18 has the substantial wedge shape, for example. That is, the slide plate 18 has a smaller cross-sectional area at one end side (e.g., upper end side of FIG. 10) thereof. Moreover, as shown in FIG. 11B, the slide plate 18 has two engagement protrusion portions 181, which are respectively arranged at two side surfaces of the slide plate 18 and extend in the slide direction of the slide plate 18. The mold plate 16 and the mold plate 17 are respectively provided with an engagement groove portion 161 and an engagement groove portion 171 which extend in a same direction with that of the engagement protrusion portion 181. The two engagement protrusion portions 181 are respectively slidably engaged with the engagement groove portions 161 and 171.

Therefore, when the slide plate 18 is slid in the pulling-out direction from the part between the mold plate 16 and the mold plate 17, the mold plate 16 is enforced to move rightward and the mold plate 17 is enforced to move leftward as shown in FIG. 11A.

Thus, the interval between the inner wall surface 16a of the mold plate 16 and the inner wall surface 17a of the mold plate 17 is enlarged. Therefore, the inner wall surface 16a and the inner wall surface 17a are separated from the fan blade 101. Accordingly, the friction binding (coupling) between the inner wall surface 16a, 17a and the fan blade 101 is decreased, so that the constraint of the fan blade 101 by the product portion 30 is released. In this case, the interval (gap) between the inner wall surfaces 16a and 17a becomes substantially equal to, for example, 0.3 mm, so that the constraint of the fan blade 101 by the mold 1 can be released.

As described above, the operation command (instruction for slide of slide plate) of the control unit 50 is performed at the time when the resin temperature of the thickness-direction middle portion of the fan blade 101 (thin-walled member) attained to the crystallization temperature.

A beforehand survey can be performed to determine the time which has elapsed until the middle portion of the thin-walled member attains to the crystallization commencement temperature from the charging of the molten resin into the product portion 30. The time is inputted via the input device 60 to be memorized in the memorizing unit by the control unit 50, and set as a first predetermined time for the timer 51.

For example, a molding test can be performed. The first predetermined time is determined such that neither crack due to a late release of the constraint nor deformation (larger than a predetermined degree) due to a too early release of the constraint occurs. The first predetermined time is beforehand set for the timer 51.

That is, the first predetermined time is obtained based on a value related to the resin temperature of the thickness-direction middle portion of the thin-walled member, and set for timer 51.

Alternatively, the first predetermined time can be also determined by directly measuring the resin temperature of the thickness-direction middle portion of the thin-walled member, without being determined based on the value related to the resin temperature of the thickness-direction middle portion.

In this case, the first predetermined time is set based on the test result, which is a property related to the shrinkage property in the cooling-solidifying course of the molten resin which is ejected and charged. Therefore, it can be said that the first predetermined temperature is set practically based on the shrinkage property in the cooling-solidifying course of the molten resin.

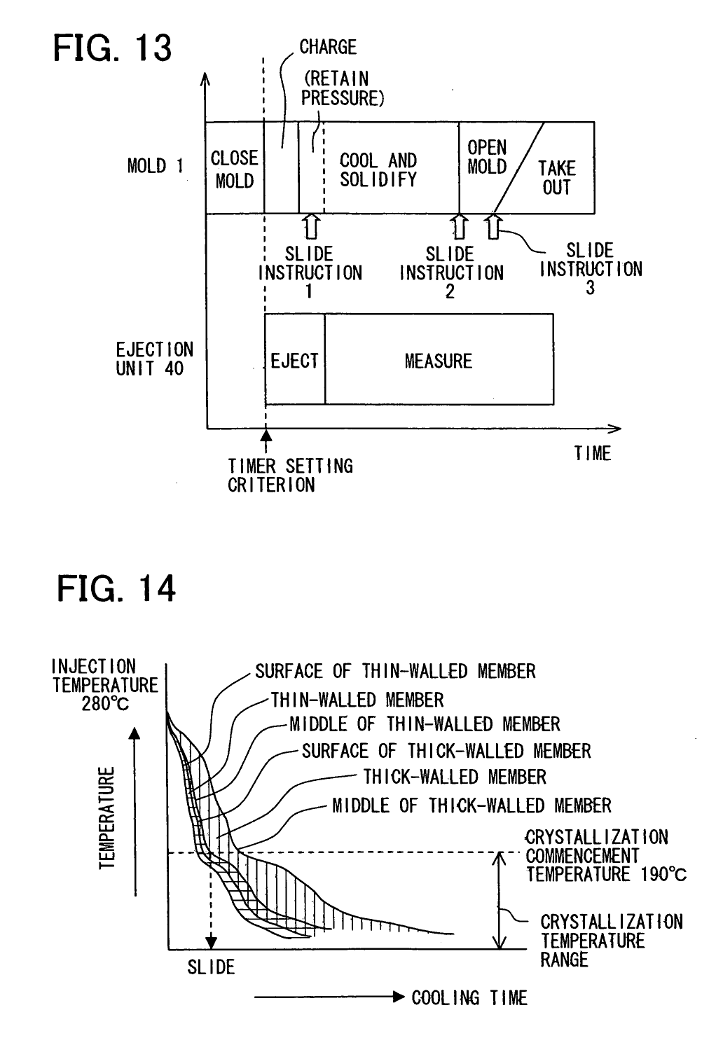

As shown in FIG. 13, the control unit 50 performs the slide instruction (slide instruction 1 shown in FIG. 13) of the slide plate 18 at the time when the timer 51 detects that the first predetermined time has elapsed from the ejection commence of the ejection unit 40 (that is, at timing when it is estimated that the crystallization of the middle portion of the thin-walled member has commenced).

In this embodiment, as shown in FIG. 13, in the cooling process for cooling and solidifying the resin which is charged, the slide instruction 1 is performed in a pressure-retaining state where the pressure (secondary pressure) is applied in the product portion 30.

In this embodiment, the constructions of the mold members 26, 27 and 28 of the movable mold unit 20 are respectively same with those of the mold members 16, 17 and 18 of the fixed mold unit 10. According to the instruction of the control unit 50 to the servo motor 29, the constraint of the fan blade 101 is released at the time when the first predetermined time has elapsed after the ejection commence of the ejection unit 40.

Thus, the cooling process is performed in such a state that the constraint of the fan blade 101 (thin-walled member) has been released. Therefore, the fan blade 101 can follow the shrinkage of the disk member 102 and the shroud ring 103, even when the crystallization shrinkage of the disk member 102 and the shroud ring 103 (which are thick-walled member) is later than the fan blade 101 and largely develops.

The slide plate 18 and the servo motor 19 (being driving unit for driving slide plate 18) construct an alteration unit for altering the interval between the thin-walled-member inner surfaces 16a and 17a (which are part of inner wall surface 30a constructing product portion 30) which are opposite to each other with the fan blade 101 being interposed therebetween. Moreover, the slide plate 28 and the servo motor 29 which is the diving unit for driving the slide plate 28 also construct an alteration unit.

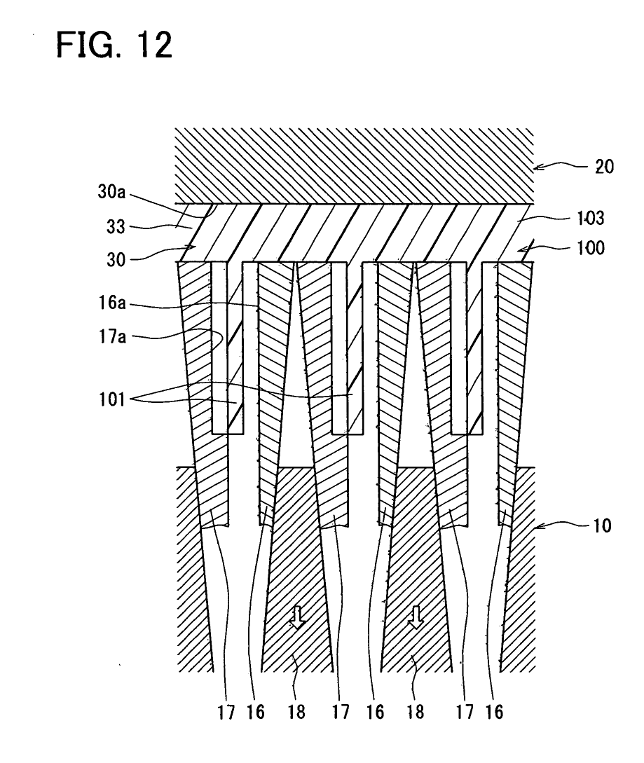

After the cooling process shown in FIG. 11A is completed, the mold-opening process will be performed as described above. In this case, the control unit 50 makes the servo motor 19 (referring to FIG. 5) operate, to further drive (corresponding to slide instruction 2 shown in FIG. 13) the slide plate 18 in the pulling-out direction from the part between the mold plate 16 and the mold plate 17 with reference to FIG. 12.

A beforehand survey can be performed to determine the time which has elapsed until the sirocco fan 100 becomes a predetermined state with a cooling-solidifying progress of the molten resin from the charging of the molten resin into the product portion 30. The time is inputted via the input device 60 and memorized in the memorizing unit by the control unit 50. The time is set as a second predetermined time for the timer 51.

As shown in FIG. 13, the control unit 50 performs the slide instruction (slide instruction 2 shown in FIG. 13) of the slide plate 18, at the time when the timer 51 detects that the second predetermined time has elapsed from the ejection commence of the ejection unit 40.

Thus, as shown in FIG. 12, the interval between the inner wall surface 16a and the inner wall surface 17a which are opposite to each other with the fan blade 101 being interposed therebetween is further enlarged. In this case, the interval (gap) between the inner wall surfaces 16a and 17a becomes substantially equal to 0.5 mm, for example. Thus, the friction binding (coupling) between the inner wall surface 16a, 17a and the fan blade 101 is further decreased.

In this case, the slide plate 28 of the movable mold unit 20 is not slid (driven), and the interval between the inner wall surface 26a of the mold plate 26 and the inner wall surface 27a of the mold plate 27 which are opposite to each other with the fan blade 101 being interposed therebetween is not altered. That is not figure-shown.

After the control unit 50 receives a signal indicating that the operation of the slide instruction 2 has been completed, the control unit 50 operates the clamping unit to perform the mold-opening process for mold-opening the mold 1. In the mold-opening process, the shroud ring 103 (102) which is the thick-walled member of the sirocco fan 100 is separated from the fixed mold unit 10 (which is part of the mold 1).

Thus, in the mold-opening process, the interval between the inner wall surface 16a and the inner wall surface 17a which are arranged at the side of the fixed mold unit 10 and opposite to each other is larger than that between the inner wall surface 26a and the inner wall surface 27a which are arranged at the side of the movable mold unit 20 and opposite to each other. Therefore, as shown in FIG. 8, at the time of the mold-opening, the sirocco fan 100 can be maintained at the side of the movable mold unit 20 because of the difference of the friction force (difference of mold-releasing force).

After the mold-opening process is completed (referring to FIG. 8) through the state shown in FIG. 12, the taking-out process will be performed as described above. That is, the taking-out process will be performed after the control unit 50 receives the signal indicating that the fixed mold unit 10 and the movable mold unit 20 are completely opened or the signal indicating that the fixed mold unit 10 and the movable mold unit 20 are separated from each other to have therebetween at least an interval through which the sirocco fan 100 can be taken out. At this time, the control unit 50 operates the servo motor 29 shown in FIG. 5, to further drive (corresponding to slide instruction 3 shown in FIG. 13) the slide plate 28 in the pulling-out direction from the part between the mold plate 26 and the mold plate 27.

In this embodiment, the time which has elapsed until the cooling process and the mold-opening process are finished from the charging of the molten resin into the product portion 30 is determined as a third predetermined time. The third predetermined time is inputted via the input device 60 and memorized in the memorizing unit by the control unit 50. The third predetermined time is beforehand for the timer 51.

As shown in FIG. 13, the control unit 50 performs the slide instruction (corresponding to slide instruction 3 shown in FIG. 13) of the slide plate 18 at the time when the timer 51 detects that the third predetermined time has elapsed from the ejection commence of the ejection unit 40.

Accordingly, the interval between the inner wall surface 26a and the inner wall surface 27a which are opposite to each other with the fan blade 101 being interposed therebetween is further enlarged. In this case, the interval (gap) between the inner wall surfaces 26a and 27a is substantially equal to 0.5 mm, for example. Thus, the friction binding (coupling) between the inner wall surface 26a, 27a and the fan blade 101 is further decreased.

When the control unit 50 received the signal indicating that the operation of the slide instruction 3 is completed, the control unit 50 operates the ejector device (not shown) to mold-release the sirocco fan 100 from the movable mold unit 20 as shown in FIG. 9 and take out the sirocco fan 100 from the part between the fixed mold unit 10 and the movable mold unit 20 via the taking-out device (not shown) or the like.

Thus, in the taking-out process, the interval between the inner wall surfaces 26a and 27a which are arranged at the side of the movable mold unit 20 and opposite to each other becomes larger than that in the mold-opening process. Therefore, when the sirocco fan 100 is taken out, the friction force (mold-release force) is restricted. Accordingly, the sirocco fan 100, which is held at the side of the movable mold unit 20 at the time of the mold-opening, can be readily taken out.

According to what described above, in the cooling process, the constraint of the fan blade 101 by the mold 1 can be released substantially simultaneously with the resin crystallization commencement of the thickness-direction middle portion of the fan blade 101 (thin-walled member).

Thus, the constraint of the fan blade 101 which has been earlier cooled and solidified is released, when the disk member 102 and the shroud ring 103 (except for parts of surface portions thereof) are cooled and crystallized to cause the crystallization shrinkage. Therefore, the fan blade 101 can move (follow) responding to the crystallization shrinkage of the disk member 102 and the shroud ring 103.

Therefore, in the cooling process, stress can be restricted from occurring at the crosswise (intersectional) connection part between the fan blade 101 and the disk member 102 and that between the fan blade 101 and the shroud ring 103. Therefore, crack can be restricted from occurring at these crosswise connection parts.

Moreover, the multiple mold members 16-18 and 26-28 construct the part of the mold 1 along the fan-blade molding portion 31. The slide plate 18 among the mold members 16-18 and the slide plate 28 among the mold members 26-28 are slid, so that the interval between the thin-walled-member inner wall surfaces 16a and 17a and that between the thin-walled-member inner wall surfaces 26a and 27a can be readily enlarged to release the constraint of the fan blade 101 by the mold 1.

Because the timing for releasing the constraint of the fan blade 101 is set based on the time (the first predetermined time) which is beforehand surveyed, it is unnecessary to arrange a sensor or the like for directly detecting whether or not the resin of the middle portion of the thin-walled member (fan blade 101) has attained to the crystallization commencement temperature.

Furthermore, as compared with the cooling process, the interval between the thin-walled-member inner wall surfaces can be further enlarged in the mold-releasing process where the mold 1 is mold-opened and the sirocco fan 100 having been solidified in the cooling process is taken out from the product portion 30.

Therefore, at the time of mold-opening the mold 1 and at the time of taking-out the sirocco fan 100, the interval between the thin-walled-member inner wall surfaces can be further enlarged so that undesired stress can be restricted from being energized at the fan blade 101 of the sirocco fan 100.

Moreover, referring to FIG. 13, the control unit 50 performs the slide instructions of the slide plate in the different processes, respectively after the first, second and third predetermined times (which are beforehand sets for timer 51) since the ejection commence of the molten resin. Therefore, the control of the alteration of the interval between the inner wall surfaces of the mold 1 becomes significantly easy.

In this case, in the mold-releasing process, the mold 1 is mold-opened to separate at least the thick-walled member 102, 103 from a part of the mold 1 when the second predetermined time has elapsed from the charging of the molten resin in the charging process, after the release of the constraint in the cooling process.

According to this embodiment, the sirocco fan 100 having the thin-walled fan blades can be provided. Therefore, a quantity increase of air supplied by the fan due to a flow-resistance decrease, a power saving due to a fan weight reduction, a fan-diameter decrease accompanying with a high-speed rotation because of a rotation-moment reduction, a material-fee reduction and the like become possible.

### Other Embodiments

Although the present invention has been fully described in connection with the preferred embodiments thereof with reference to the accompanying drawings, it is to be noted that various changes and modifications will become apparent to those skilled in the art.

In the above-described first embodiment, the three mold members 16-18 are arranged between the adjacent fan blades 101 which are the thin-walled members of the sirocco fan 100. In the cooling process, the one mold member (slide plate 18) is slid so that the constraint of the fan blade 101 is released when the crystallization of the middle portion of the thin-walled member begins.

However, the part of the mold 1 along the thin-walled member can be also constructed of at least two mold members. In this case, at least one of the mold members is slid to release the constraint of the thin-walled member by the mold 1.

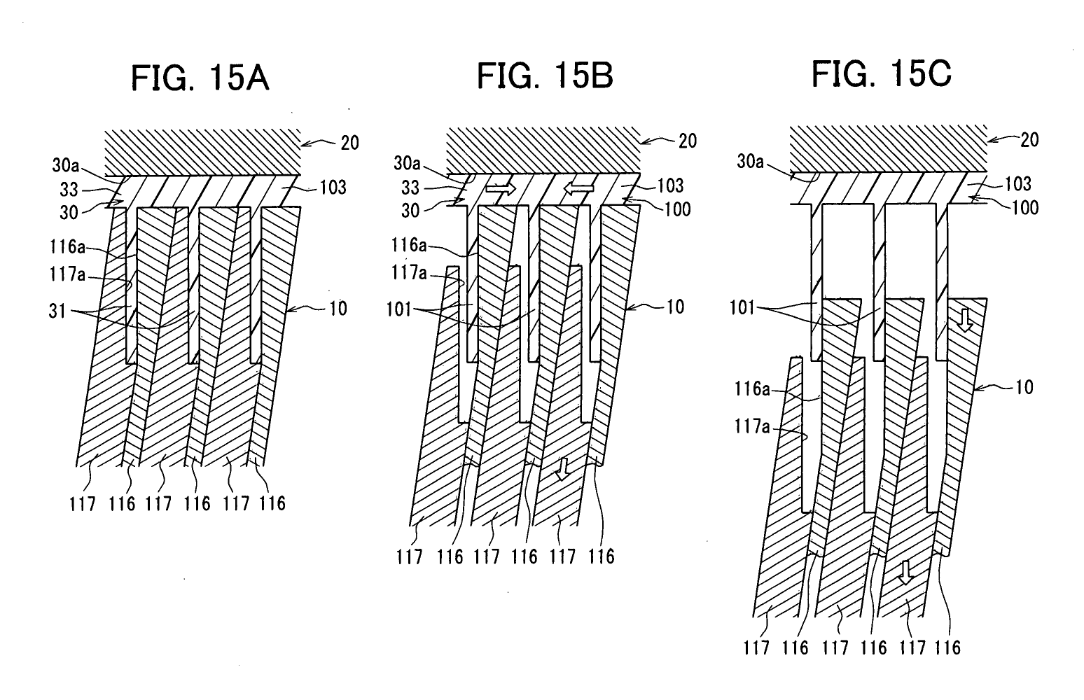

For example, referring to FIG. 15A, the part of the mold 1 along the fan blade 101 (thin-walled member) can be constructed of the mold members 116 and 117. For example, the mold members 116 and 117 can be respectively a mold plate and a slide plate, which are tiered, for example.

As shown in FIG. 15B, at the substantially same time with the attainment of the middle portion of the fan blade 101 to the crystallization commencement temperature, the mold member 117 having the substantial wedge shape is driven to slide in the direction (substantially same with extension direction of the fan blade 101) along the incline surface of the wedge shape. Thus, the interval between thin-walled-member inner wall surfaces 116a and 117a which are opposite to each other with the fan blade 101 being interposed therebeween can be enlarged, so that the constraint of the fan blade 101 is released.

Thus, as shown in FIG. 15C, when the mold 1 is mold-opened, both the mold member 116 and the mold member 117 are moved in the direction same with the extension direction of the fan blade 101.

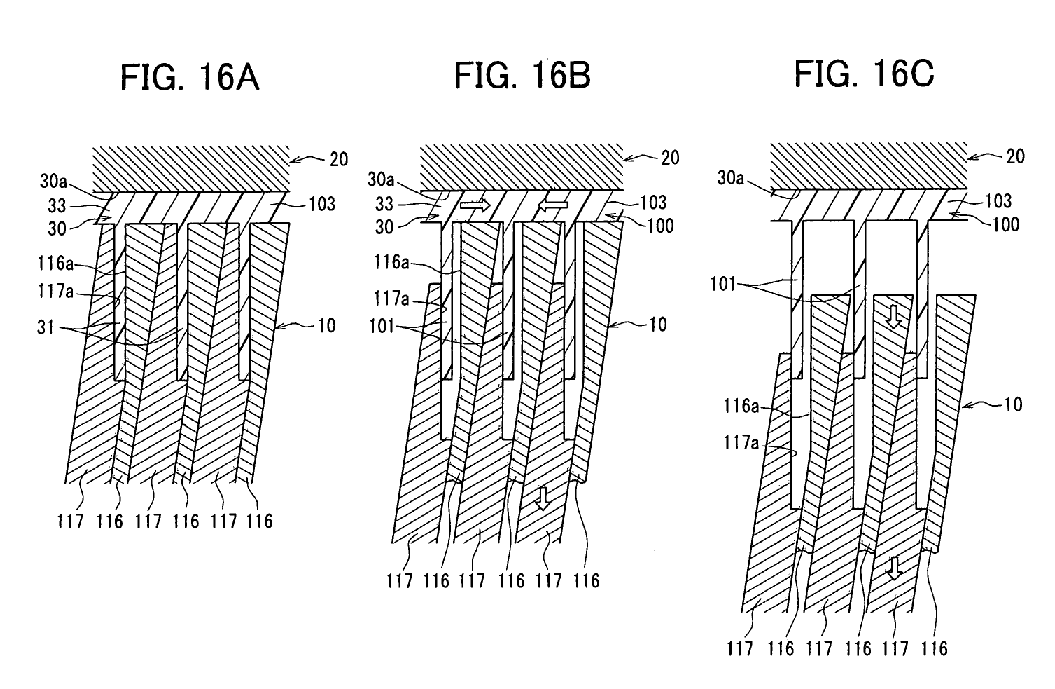

Alternatively, referring to FIG. 16A, the part of the mold 1 along the fan blade 101 (thin-walled member) is constructed of the two mold members 116 and 117. As shown in FIG. 16B, at the substantially same time with the attainment of the middle portion of the fan blade 101 to the crystallization commencement temperature, the mold member 117 having the substantial wedge shape is driven to slide in the direction substantially same with the extension direction of the fan blade 101. Thus, the interval between the thin-walled-member inner wall surfaces 116a and 117a which are opposite to each other with the fan blade 101 being inserted therebeween is enlarged, so that the constraint of the fan blade 101 is released.

Then, as shown in FIG. 16C, when the mold 1 is mold-opened, both the mold members 116 and 117 are moved in the direction substantially same with the extension direction of the thin-walled member 101.

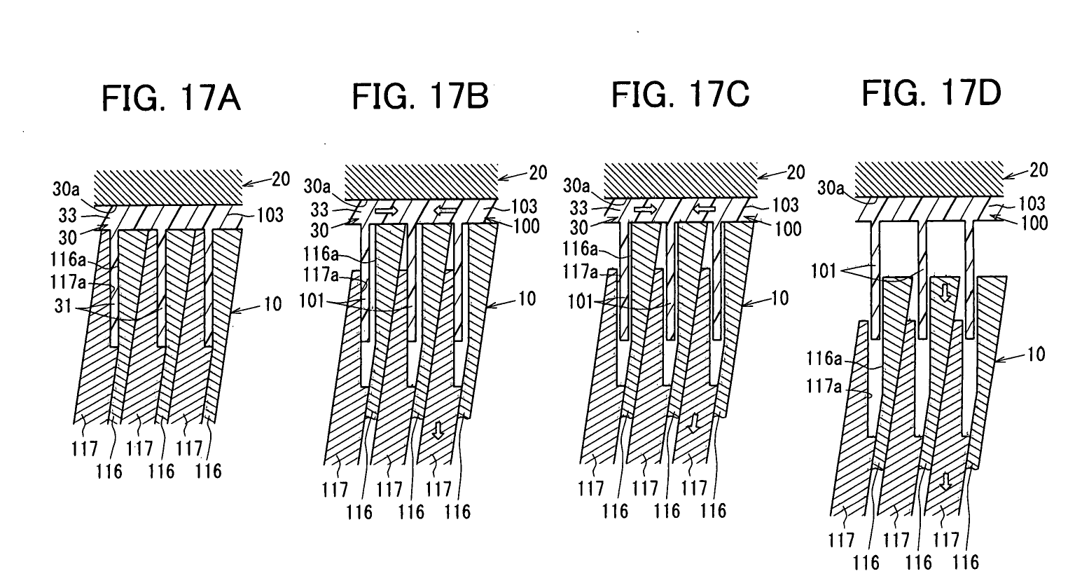

More alternatively, as shown in FIG. 17A, the part of the mold 1 along the fan blade 101 (thin-walled member) is constructed of the two mold members 116 and 117. As shown in FIG. 17B, at the substantially same time with the attainment of the middle portion of the fan blade 101 to the crystallization commencement temperature, the mold member 117 having the substantial wedge shape is driven to slide in the direction substantially same with the extension direction of the fan blade 101. Furthermore, as shown in FIG. 17C, the mold member 117 is driven to further slide in the direction (substantially same with extension direction of fan blade 101) along the incline surface of the wedge shape. Thus, the interval between the thin-walled-member inner wall surfaces 116a and 117a which are opposite to each other with the fan blade 101 being inserted therebeween can be enlarged, so that the constraint of the fan blade 101 can be substantially released.

Thus, referring to FIG. 17D, when the mold 1 is mold-opened, both the mold members 116 and 117 are moved in the direction substantially same with the extension direction of the fan blade 101.

In this case, the process shown in FIG. 17B can be also performed simultaneously with the process shown in FIG. 17C. That is, the mold member 117 can be slid in a middle direction between the direction shown in FIG. 17B and that shown in FIG. 17C. Thus, the thin-walled-member inner wall surfaces 116a and 117a are simultaneously separated from the fan blade 101.

As described above, the part of the mold 1 along the thin-walled member 101 can be constructed of the two tiers of mold members. As compared with the case where the part of the mold 1 along the thin-walled member 101 is constructed of the three tiers of mold members (referring to first embodiment), the construction of the mold 1 can be simplified and the strength of the mold member between the adjacent thin-walled members can be readily ensured even when the thin-walled members are near to each other.

Furthermore, in the first embodiment, the slide direction of the slide plate 18, 28 is substantially same with the extension direction of the thin-walled member 101. However, the slide plate can be also slid in a direction substantially same with an extension direction, which tilts with respect to the extension direction of the thin-walled member 101.

Moreover, in the first embodiment, referring to FIG. 13, the first-third predetermined times after the commence of charging the molten resin into the product portion 30 of the mold 1 via the ejection unit 40 are beforehand set for the timer 51. The timer 51 counts the time elapsed from the commence of charging the molten resin. When it is respectively determined that the first-third predetermined times have elapsed, the slide instructions 1-3 are respectively performed. However, the timer 51 can be also provided with the time setting criterion other than the commence time of charging the molten resin, on condition that the time elapse equivalent to the first, second, third predetermined time after the commence of charging the molten resin can be detected.

For example, the commence time of mold-closing can be used as the time setting criterion for the timer 51. In this case, the timer 51 can count from the commence of mold-closing, to determine whether or not the predetermined time has elapsed from the commence of charging the molten resin.

Moreover, in the first embodiment, the slide plate 18 is slid so that the mold plates 16 and 17 are enforcedly separated from the fan blade 101. Thus, the constraint of the fan blade 101 by the mold 1 is released. However, the constraint of the fan blade 101 can be also released by making the mold plates 16 and 17 free, without enforcedly moving the mold plates 16 and 17.

Furthermore, in the first embodiment, the servo motors 19 and 29 are respectively used as the driving units of the slide plates 18 and 28. However, a hydraulic cylinder or the like can be also used as the driving unit.

Moreover, the manufacture method can be also suitably used for the molded product other than the sirocco fan 100. The manufacture method can be used for a molded product where there is a crosswise arrangement between a thick-walled member and a thin-walled member (which thickness is smaller than thick-walled member). For example, the manufacture method can be used for the centrifugal fan such as a turbo fan, which has fan blades thinner than other member thereof.

Moreover, in the first embodiment, the first predetermined time is set, for the releasing of the constraint of the thin-walled member 101 corresponding to the difference between the shrinkage states (accompanying with crystallization) of the thin-walled member 101 and the thick-walled member 102, 103 of the molded product 100. However, the first predetermined time can be also set in other manner, on condition that the constraint of the thin-walled member 101 is released corresponding to the difference (which causes crack and the like) between the shrinkage states. That is, the first predetermined time can be set based on the shrinkage property in the cooling-solidifying course of the molten resin or a property related to the shrinkage property.

For example, the first predetermined time can be set by experientially determining via a molding test or by directly determining an occurrence timing of a predetermined volume shrinkage difference or the like, in the case where the volume shrinkage difference between the thin-walled member and the thick-walled member before the crystallization commence of the resin (which is cooled and solidified) is large so that crack occurs due to the stress caused by the volume shrinkage difference.

Moreover, the manufacture method can be also used for the molded product which is made of other material, for example, an amorphous resin which is not crystallized. In this case, the first predetermined time can be set, for the releasing of the constraint of the thin-walled member corresponding to the difference between the shrinkage states of the thick-walled member and the thin-walled member of the molded product made of the amorphous resin.

Such changes and modifications are to be understood as being in the scope of the present invention as defined by the appended claims.

What is claimed is:

1. A manufacture method for a molded product having at least a thick-walled member and at least a thin-walled member which are crosswise arranged, the thin-walled member having a smaller thickness than the thick-walled member, the manufacture method comprising:
a charging process for ejecting and charging a molten resin into a product portion of a mold having been mold-closed;
a cooling process for cooling and solidifying the molten resin in a constraint state in the product portion, the molten resin having been charged into the product portion in the charging process; and
a mold-releasing process for mold-opening the mold and taking out the molded product from the production portion, the molded product having been solidified in the cooling process, wherein:
in the cooling process, the constraint of the thin-walled member by the mold is released when a first predetermined time has elapsed from the charging of the molten resin in the charging process; and
in the mold-releasing process, the mold is mold-opened to separate at least the thick-walled member from a part of the mold when a second predetermined time has elapsed from the charging of the molten resin in the charging process, after the release of the constraint in the cooling process.

2. The manufacture method according to claim 1, wherein
the first predetermined time is set based on one of a shrinkage property of the molten resin in a course of the cooling and solidifying and a property related to the shrinkage property.

3. The manufacture method according to claim 1, wherein
in the cooling process, an interval between thin-walled-member inner wall surfaces which are opposite to each other with the thin-walled member being interposed therebetween is enlarged to reduce a friction binding between the thin-walled member and the thin-walled-member inner wall surface so that the constraint of the thin-walled member is released,
the thin-walled-member inner wall surfaces being parts of an inner wall surface of the mold, the inner wall surface constructing the production portion.

4. The manufacture method according to claim 1, wherein
in the cooling process, an interval between thin-walled-member inner wall surfaces which are opposite to each other with the thin-walled member being interposed therebetween is enlarged when the first predetermined time has elapsed, so that a friction binding between the thin-walled member and the thin-walled-member inner wall surface is reduced to release the constraint of the thin-walled member,
the first predetermined time being determined from one of a resin temperature of a thickness-direction middle portion of the thin-walled member and a value related to the resin temperature,
the thin-walled-member inner wall surfaces being parts of an inner wall surface of the mold, the inner wall surface constructing the production portion.

5. The manufacture method according to claim 3, wherein:
the mold has a part along the thin-walled member, the part being constructed of a plurality of mold members; and
in the cooling process, at least one of the mold members is slid to enlarge the interval between the thin-walled-member inner wall surfaces.

6. The manufacture method according to claim 3, wherein
in the mold-releasing process, the interval between the thin-walled-member inner wall surfaces is further enlarged with respect to the cooling process.

7. The manufacture method according to claim 3, wherein:
the mold includes a fixed mold unit and a movable mold unit, which respectively have the thin-walled-member inner wall surfaces opposite to each other with the thin-walled member being interposed therebetween; and
when the mold is mold-opened in the mold-releasing process, the interval between the thin-walled-member inner wall surfaces of the fixed mold unit is larger than that between the thin-walled-member inner wall surfaces of the movable mold unit.

8. The manufacture method according to claim 7, wherein
when the molded product is taken out from the product portion in the mold-releasing process, the interval between the thin-walled-member inner wall surfaces of the movable mold unit is further enlarged with respect to the cooling process.

9. The manufacture method according to claim 1, wherein:
the product portion of the mold has at least one thin-walled-member molding portion for molding the at least one thin-walled member;
the mold has therein at least one gate, which is arranged in an extension direction of the thin-walled-member molding portion; and
in the charging process, the molten resin is injected toward the thin-walled-member molding portion from the gate.

10. The manufacture method according to claim 9, wherein:
the molded product has the plurality of the thin-walled members;
the product portion of the mold has the plurality of thin-walled-member molding portions, corresponding to which the plurality of gates are respectively arranged in the mold; and
in the charging process, the molten resin is injected toward the thin-walled-member molding portion from the gate which is arranged corresponding to the thin-walled-member molding portion.

11. The manufacture method according to claim 1, wherein
in the charging process, a temperature of an inner wall surface of the mold is substantially equal to a predetermined temperature, which is set based on a flow property and a shrinkage property of the resin which is ejected and charged.

12. The manufacture method according to claim 1, wherein:
the molded product is manufactured via a molding device, which includes the mold having the product portion shaped corresponding to the molded product, an ejecting charging unit for ejecting and charging the molten resin into the production portion, and a control unit for controlling operations of the mold and the ejecting charging unit; and
the control unit releases the constraint of the thin-walled member by the mold when the first predetermined time has elapsed from the charging of the molten resin into the product portion by the ejecting-charging unit, via a timer unit for which the first predetermined time is beforehand set.

13. The manufacture method according to claim 12, wherein:
the mold has a part along the thin-walled member, the part being constructed of a plurality of mold members; and
the control unit slides at least one of the mold members to enlarge an interval between thin-walled-member inner wall surfaces which are opposite to each other with the thin-walled member being interposed therebetween,
the thin-walled-member inner wall surfaces being parts of an inner wall surface of the mold, the inner wall surface constructing the production portion.

14. The manufacture method according to claim 12, wherein
the control unit enlarges an interval between thin-walled-member inner wall surfaces when the first predetermined time has elapsed, so that a friction binding between the thin-walled member and the thin-walled-member inner wall surface is reduced to release the constraint of the thin-walled member,
the thin-walled-member inner wall surfaces being opposite to each other with the thin-walled member being interposed therebetween and being parts of an inner wall surface of the mold, the inner wall surface constructing the production portion,
the first predetermined time being determined from one of a resin temperature of a thickness-direction middle portion of the thin-walled member and a value related to the resin temperature.

15. The manufacture method according to claim 12, wherein
when the mold is mold-opened and the solidified molded product is taken out from the product portion, the control unit further enlarges an interval between thin-walled-member inner wall surfaces with respect to the cooling process,
the thin-walled-member inner wall surfaces being opposite to each other with the thin-walled member being interposed therebetween and being parts of an inner wall surface of the mold, the inner wall surface constructing the production portion.

16. The manufacture method according to claim 5, wherein:
the at least one of the mold members of the mold has a substantial wedge shape to be slidable; and
the mold has a driving unit for driving the at least one mold member so that the at least one mold member slides.

17. The manufacture method according to claim 16, wherein:
the mold has the three mold members;
a middle one of the three mold members is the slidable mold member; and
the driving unit drives the slidable mold member so that the slidable mold member slides in a direction substantially same with an extension direction of the thin-walled member.

18. The manufacture method according to claim 16, wherein:
the mold has the two mold members;
one of the two mold members is the slidable mold member; and
the driving unit drives the slidable mold member in a direction substantially same with an extension direction of the thin-walled member.

19. The manufacture method according to claim 1, wherein:
the molded product is a centrifugal fan; and
the thin-walled members are fan blades of the centrifugal fan.

20. The manufacture method according to claim 19, wherein
the thick-walled members are a shroud ring and a disk member of the centrifugal fan.
